(19) United States
(12) Patent Application Publication
(10) Pub. No.: US 2023/0242029 A1
(43) Pub. Date: Aug. 3, 2023

(54) FALSE BULKHEAD ASSEMBLY AND METHOD FOR RETAINING A FLEXIBLE BULKHEAD

(71) Applicant: Mac LTT, Inc., Kent, OH (US)

(72) Inventor: James A. Maiorana, Hartville, OH (US)

(73) Assignee: Mac LTT, Inc., Kent, OH (US)

(21) Appl. No.: 17/587,125

(22) Filed: Jan. 28, 2022

(51) Int. Cl. B60P 3/22; B65D 90/02

(52) U.S. Cl. CPC B60P 3/2215; B60P 3/221; B65D 90/02

(57) ABSTRACT

A false bulkhead assembly for engagement with a vehicle, said false bulkhead assembly comprising a frame adapted to be engaged with the vehicle and a cover operably engaged with the frame. The false bulkhead assembly is provided to effectively hide a front bulkhead or a rear bulkhead of a tank trailer. The false bulkhead assembly is provided to hide from public view any staining from the overflow of accumulated precipitation from a trough or other structure on the tank body. The false bulkhead assembly is also provided to display graphics and other similar visual images to provide advertising and marketing characteristics to a specific company when using this false bulkhead assembly of a specific tank trailer or tank vehicle.

### TECHNICAL FIELD

The present disclosure is directed to a trailer. More particularly, the present disclosure is directed to exterior assemblies for a tank trailer. Specifically, the present disclosure is directed to a false, flexible bulkhead assembly for a trailer. The false bulkhead assembly is configured to display graphics and other similar visual images while also hiding, from public view, unwanted stains or blemishes that form on an associated front or rear bulkhead of the trailer due to overflow of accumulated precipitation from an upper region of the trailer.

### BACKGROUND

Tank trailers and tank vehicles that are designed to transport any liquid or gaseous materials within an associated tank or tanks are greatly regulated under United States federal law. These restrictions are implemented into this specific market to help improve safety and protection when transporting hazardous and/or dangerous liquid or gaseous loads inside of these tank trailers and tank vehicles. With such regulations, current manufacturers of tank trailers and tank vehicles are limited to making various modifications to said tank trailers and tank vehicles. As such, current tank trailers and tank vehicles in the marketplace are substantially similar to one another due to these regulations.

Moreover, tank trailers, tank vehicles, and other similar enclosed trailers and vehicles experience different types of weather and precipitation depending on the climate and region in which the tank trailers operated. Generally, tank trailers include a trough or a similar enclosure on a top portion of the trailer for specific purposes based on the type of tank trailer. These troughs can accumulate rainwater or other types of precipitation therein when the tank trailers are stationary and parked or when in operation and being towed by a vehicle (e.g., a semi-trailer truck). Such accumulation of rainwater or other precipitation inside of the trough may spill over the trough and onto the front or rear exterior bulkheads of the trailer. Such spilling can cause unwanted stains or grime on the front end or the rear end of the trailer. Even more so, these unwanted stains or grime can be seen by bystanders or drivers near the trailer, which could ultimately confuse these bystanders or drivers that the drainage stains or grime are leaking material or liquid stains loaded in the trailer (e.g., gasoline, hazardous chemicals, etc.). In other words, the harmless spilling of precipitation from the trough of a trailer could create unwanted concerns and logistic delays due to drivers noticing these stains as a potential hazard on the road.

### SUMMARY

The false bulkhead assembly disclosed herein is provided to effectively hide a front bulkhead or a rear bulkhead of a tank trailer. The false bulkhead assembly is provided to hide from public view any staining from the overflow of accumulated precipitation from a trough or other structure on the tank body. The false bulkhead assembly is also provided to display graphics and other similar visual images to provide advertising and marketing characteristics to a specific company when using this false bulkhead assembly of a specific tank trailer or tank vehicle. The provision of the false bulkhead assembly does not require any modification of the actual tank trailer itself and therefore the tank trailer remains in compliance with federal regulations. As such, the false bulkhead assembly with a tank trailer or tank vehicle disclosed herein addresses some of the inadequacies of previously known tank trailers or tank vehicles lacking such false bulkhead assembly.

In one aspect, an exemplary embodiment of the present disclosure may provide a false bulkhead assembly for engagement with a vehicle. The false bulkhead assembly comprises a frame adapted to be engaged with the vehicle; and a cover operably engaged with the frame.

This exemplary embodiment or another exemplary embodiment may further provide that the frame is removably engaged with the vehicle. This exemplary embodiment or another exemplary embodiment may further provide that the cover is selectively positionable outwardly from a wall of the vehicle. This exemplary embodiment or another exemplary embodiment may further provide that the cover is selectively positionable parallel to the wall of the vehicle. This exemplary embodiment or another exemplary embodiment may further provide that the cover is a fibrous material. This exemplary embodiment or another exemplary embodiment may further provide a retaining member operable to secure the cover to the frame. This exemplary embodiment or another exemplary embodiment may further provide a clip provided on the frame and operable to secure the frame to a wall of the vehicle. This exemplary embodiment or another exemplary embodiment may further provide graphics provided on the cover.

In another aspect, an exemplary embodiment of the present disclosure may provide in combination a trailer comprising a main body having a front bulkhead, a rear bulkhead, and an exterior wall extending between the front bulkhead and the rear bulkhead; and a false bulkhead assembly positioned adjacent one of the front bulkhead and the rear bulkhead of the trailer.

This exemplary embodiment or another exemplary embodiment may further provide that the trailer further comprises an attachment portion; wherein the false bulkhead assembly is removably engageable with the attachment portion. This exemplary embodiment or another exemplary embodiment may further provide the false bulkhead assembly further comprises: a frame operably engageable with the attachment portion; and a cover operably engaged with the frame. This exemplary embodiment or another exemplary embodiment may further provide the false bulkhead assembly further includes graphics provided on the cover. This exemplary embodiment or another exemplary embodiment may further provide that the frame further comprises a base wall; and a clip extending from the base wall, wherein the clip is configured to operably engage the frame with the attachment portion of the trailer. This exemplary embodiment or another exemplary embodiment may further provide that the clip further comprises a support arm extending away from the base wall; and an attachment arm extending outwardly away from a first end of the support arm, wherein the attachment arm and support arm are moveable between a straight position and a bent position when operably engaging the attachment arm with the attachment portion. This exemplary embodiment or another exemplary embodiment may further provide that the clip further comprises: a protrusion extending away from an opposing second end of the attachment arm, wherein the protrusion is configured to operably engage with the attachment portion. This exemplary embodiment or another exemplary embodiment may further provide that the attachment portion further comprises a groove extending into the attachment portion, wherein the groove is configured to receive and house the protrusion. This exemplary embodiment or another exemplary embodiment may further provide that the false bulkhead assembly further comprises a retaining member configured to retain the cover with the frame.

In another aspect, and exemplary embodiment of the present disclosure may provide a method of concealing a bulkhead of a vehicle. The method comprises the steps of providing a false bulkhead assembly including a frame and a cover; engaging the frame with an attachment portion of the vehicle; and hiding a region of the vehicle with the cover.

This exemplary embodiment or another exemplary embodiment may further provide steps of engaging a clip of the frame with the attachment portion of the vehicle; and securing a cover with the frame via a retaining member. This exemplary embodiment or another exemplary embodiment may further provide steps of inserting a portion of the cover into a recess defined by the clip of the frame; inserting the retaining member into the recess defined by the clip of the frame; and retaining the portion of the cover, via the retaining member, within the recess of the clip.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 (FIG. 1) is left side elevation view of a trailer operably engaged with a vehicle, wherein the trailer is equipped with a false bulkhead assembly in accordance with an aspect of the present disclosure.

FIG. 2 (FIG. 2) is a rear elevation view of the trailer equipped with the false bulkhead assembly shown in FIG. 1.

FIG. 3 (FIG. 3) is a partial top plan view of the trailer equipped with the false bulkhead assembly taken in the direction of line 3-3 shown in FIG. 1.

FIG. 4A (FIG. 4A) is a partial top, rear, left side isometric perspective view of the trailer equipped with the false bulkhead assembly shown in FIG. 1.

FIG. 4B (FIG. 4B) is an exploded isometric perspective view of the trailer and the false bulkhead assembly.

FIG. 5 (FIG. 5) is a partial sectional view of the trailer equipped with the false bulkhead assembly taken in the direction of line 5-5 shown in FIG. 4A.

FIG. 6A (FIG. 6A) is an operational view of the false bulkhead assembly being introduced to an attachment portion of the trailer.

FIG. 6B (FIG. 6B) is another operational view similar to FIG. 6A, but the false bulkhead assembly is operably engaged with the attachment portion of the trailer.

FIG. 6C (FIG. 6C) is another operational view similar to FIG. 6B, but a cover and retaining member of the false bulkhead assembly are introduced to a clip of the false bulkhead assembly.

FIG. 6D (FIG. 6D) is another operational view similar to FIG. 6C, but the cover is retained inside of the clip via the retaining member operably engaged within the clip.

FIG. 7 (FIG. 7) is an exemplary method flowchart for concealing a rear bulkhead and exterior components of a trailer.

Similar numbers refer to similar parts throughout the drawings.

### DETAILED DESCRIPTION

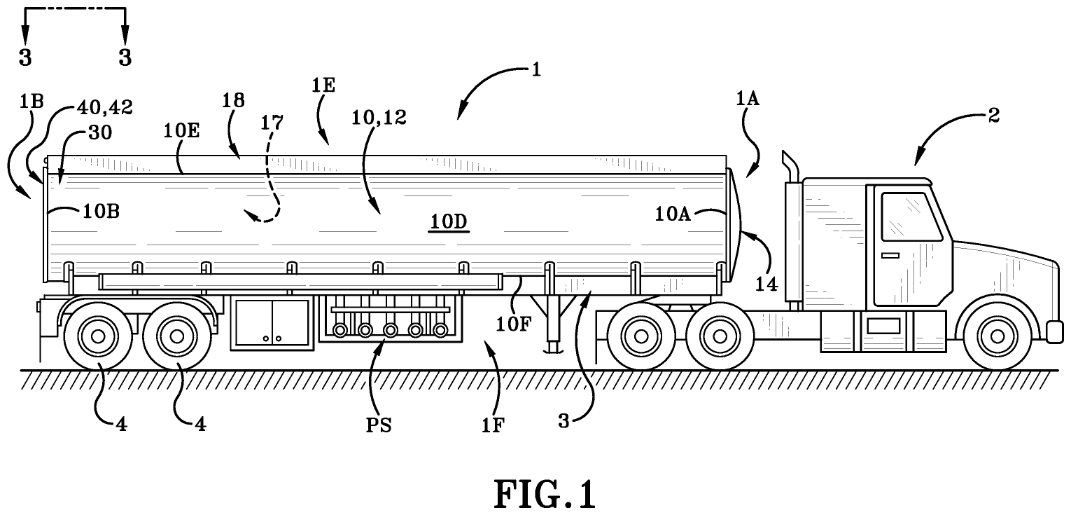

FIG. 1 illustrates a trailer or towed vehicle, which is generally indicated by the reference number 1. The trailer 1 illustrated in FIG. 1 is a tank trailer. It will be understood that the illustrated trailer 1 is exemplary only and any type of trailer is contemplated to be represented by the illustrated trailer. Exemplary trailers considered suitable herein include enclosed trailers, dry van trailers, dump trailers, transfer trailers, pneumatic tank trailers, liquid tank trailers, horse trailers, livestock trailers, tilt trailers, utility trailers, and any other similar trailers of the like for the purpose of being towed.

As illustrated in FIG. 1, the trailer 1 has a front end 1A, an opposing rear end 1B, and a longitudinal direction defined therebetween where the trailer 1 may travel forwardly and backwardly along the longitudinal direction when operably engaged with a towing vehicle (described below). The trailer 1 also has a first side or left side 1C, an opposing second side or right side 1D, and a transverse direction defined therebetween where the trailer 1 may travel laterally (i.e., turning left and/or right) along the transverse direction when operably engaged with a towing vehicle (described below). The trailer 1 may also have a top end 1E, an opposing bottom end 1F, a vertical direction defined therebetween.

It should be understood that the terms “front,” “rear,” “left,” “right,” “top,” “bottom,” and other directional derivatives used herein are to describe the orientation of the trailer 1 and associated components or assemblies of the trailer 1 illustrated in the attached figures. Such use of these terms herein should in no way be considered to limit the orientation in which the trailer 1 and associated components or assemblies of the trailer 1 may be utilized during operation.

Still referring to FIG. 1, the trailer 1 may be mechanically connected to a vehicle or towing vehicle, which is generally indicated by the reference number 2. In FIG. 1, the vehicle 2 is a semi-trailer truck mechanically connected to the trailer 1. It will be understood that the illustrated vehicle 2 is exemplary only and any type of vehicle is contemplated to be represented by the illustrated vehicle. Exemplary vehicles considered suitable herein include motorcycles, all-terrain vehicles, cars, sport utility vehicles (SUV), pickup trucks, vans, recreational vehicles, commercial trucks, and any other vehicles of the like for the purpose of towing a trailer.

Still referring to FIG. 1, the trailer 1 may include a main body 10. The main body 10 may be operably engaged with a frame 3 of the trailer 1. The frame 3 includes at least one wheel and/or tire 4 operably engaged with the frame 3 for suitable moving and transporting the trailer 1 with the vehicle 2. The frame 3 may include any suitable components and/or assemblies for loading and unloading material or matter from the main body 10, parking and maintaining the trailer 1 when disconnected from the vehicle 2, providing energy or power to the trailer when disconnected from the vehicle 2, and other suitable components and/or assemblies of the like.

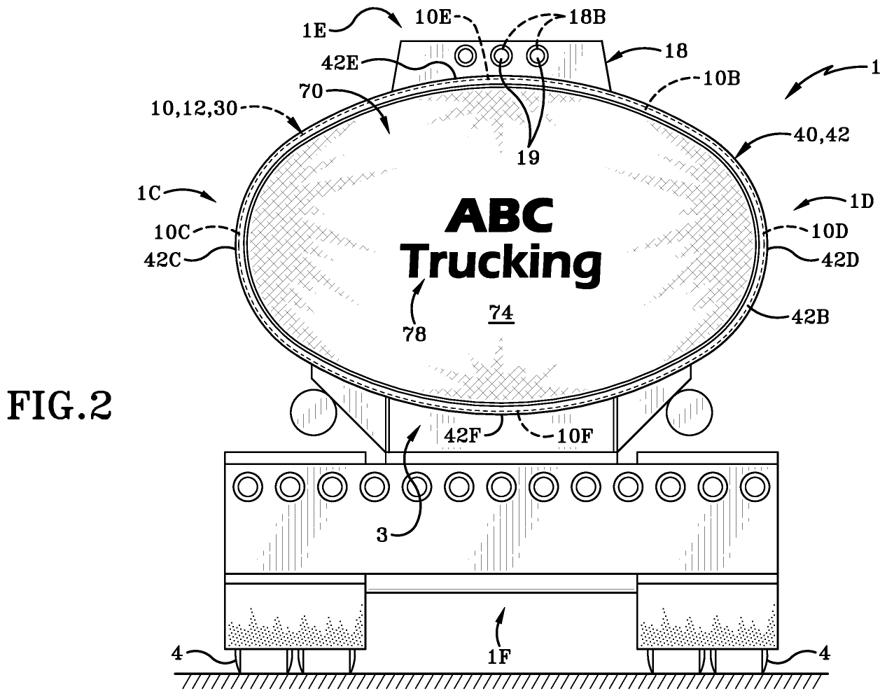

Referring to FIGS. 1 and 2, the main body 10 may have a front end 10A, an opposing rear end 10B, and a longitudinal axis defined therebetween. The main body 10 also has a first side or left side 10C, an opposing second side or right side 10D, and a transverse axis defined therebetween. The main body 10 also has a top end 10E, an opposing bottom end 10F, and a vertical axis defined therebetween. The main body 10 also includes an exterior wall or circumferential wall 12 that extends from the front end 10A to the rear end 10B along the longitudinal axis. The circumferential wall 12 also operably engages with frame 3 for maintaining the main body 10 with the frame 3.

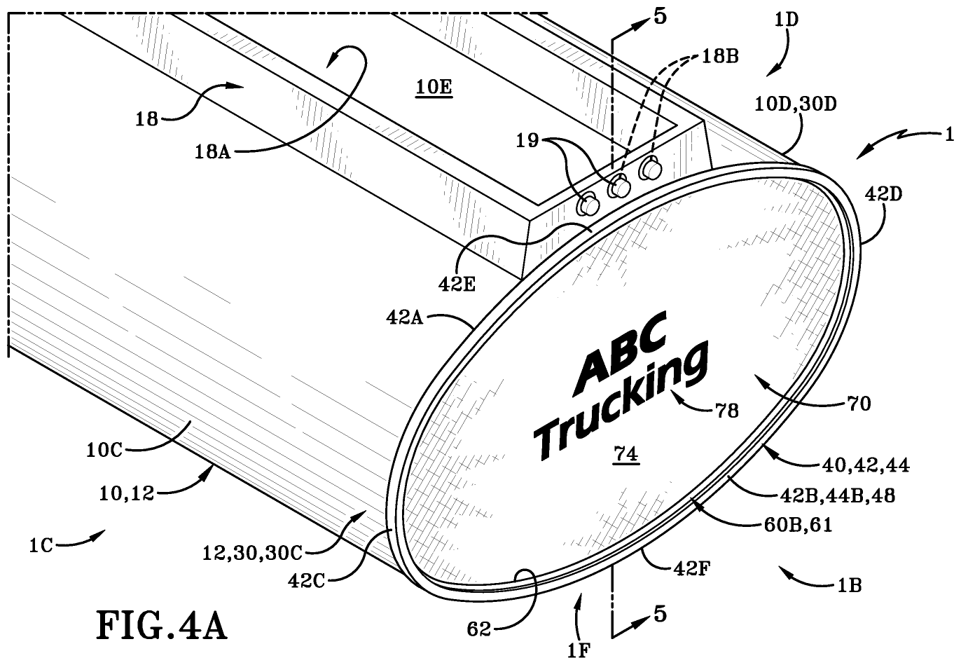

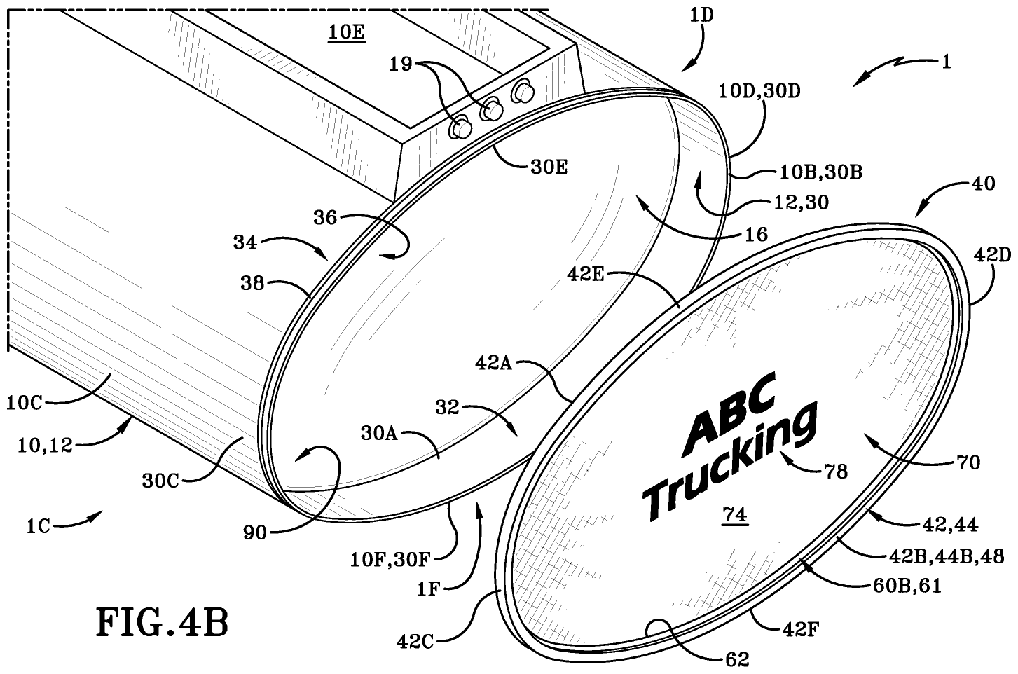

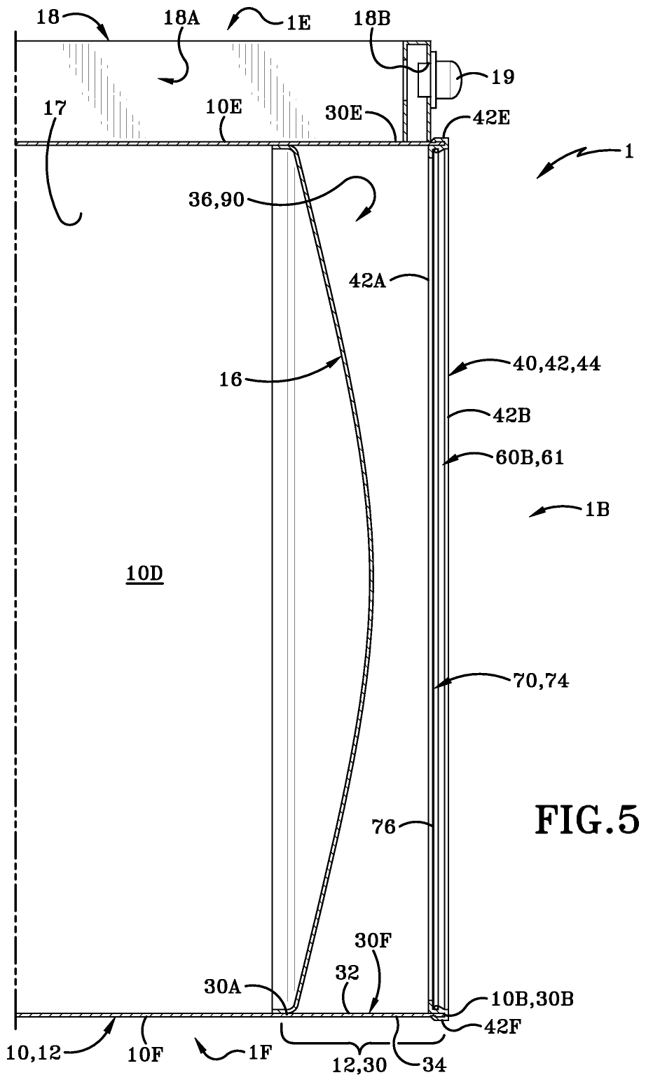

Referring to FIG. 1, the main body 10 may include a front bulkhead 14 operably engaged with the circumferential wall 12 at the front end 10A of the main body 10 proximate to the vehicle 2. The main body 10 may also include an opposing rear bulkhead 16 (see FIGS. 4B and 5) operably engaged with the circumferential wall 12 at the rear end 10B of the main body 10. Additionally, the circumferential wall 12, the front bulkhead 14, and the rear bulkhead 16 may collectively define at least one interior chamber 17 that extends from the front bulkhead 14 to the rear bulkhead 16 (see FIG. 5).

The at least one interior chamber 17 may be accessible at various location along the main body 10 for loading material into the at least one interior chamber 17 and/or and for unloading product or material from the at least one interior chamber 17. As illustrated in FIG. 1, a piping system “PS” of the trailer 1 may be in fluid communication with the at least one interior chamber 17 of the main body 10 for loading material into the at least one interior chamber 17 and for unloading product or material from the at least one interior chamber 17. In other exemplary embodiments, any suitable number of inlets and outlets may be defined in the main body 10 for loading material into the at least one interior chamber 17 and for unloading product or material from the at least one interior chamber 17.

While the main body 10 defines at least one interior chamber 17 accessible by the piping system “PS”, any suitable number of interior chambers may be defined by the main body and accessible by any suitable number of pipes in a piping system. In one exemplary embodiment, a main body may include an interior bulkhead positioned between a front bulkhead and a rear bulkhead where the main body defines a first interior chamber between the front bulkhead and the interior bulkhead and a second interior chamber between the rear bulkhead and the interior bulkhead. In another exemplary embodiment, a main body may include a plurality of interior bulkheads positioned between a front bulkhead and a rear bulkhead where the main body defines a plurality of interior chambers between each interior bulkhead, the front bulkhead, and the rear bulkhead.

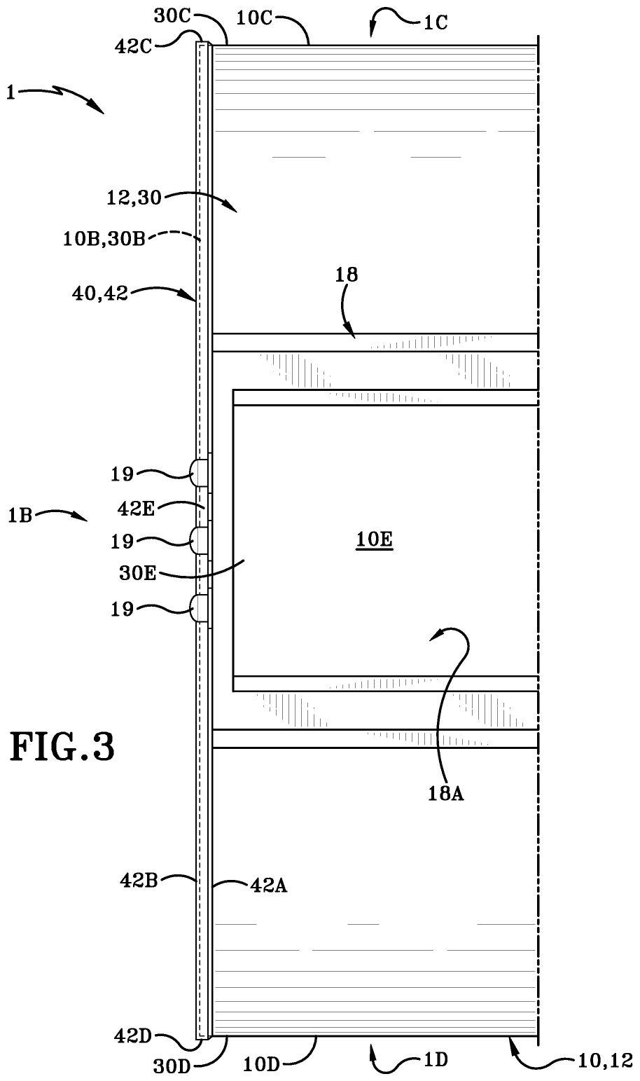

Referring to FIGS. 1-4B, the main body 10 may include a trough 18. The trough 18 may be operably engaged with the main body 10 along the top end 10E of the main body 10. The trough 18 may extend between the front and rear ends 10A, 10B of the main body 10. In the illustrated embodiment, the trough 18 extends beyond the rear bulkhead 16 (see FIGS. 4B-5). The trough 18 may also extend beyond the front bulkhead 14 and the rear bulkhead 16 of the main body 10. The trough 18 may define a channel 18A that extends along the entire length of the trough 18 parallel to the longitudinal axis of the trailer 1. The channel 18A defined by the trough 18 may be configured to gather and capture liquid or fluid that enters into the channel 18A. For example, the trough 18 may gather or collect rainwater or other forms of precipitation in the channel 18A. Additionally, the trough 18 may be configured to convey rainwater or other forms of precipitation in liquid form from the top end 10E of the main body 10 towards an on-board drainage system of the trailer 1, which is described in more detail below.

Referring to FIG. 5, the trough 18 may define a plurality of through-holes 18B at the rear end 10B of the main body 10. The plurality of through-holes 18B defined by the trough 18 may be configured to receive and house a set of brake lights 19 where the set of brake lights 19 is operably engaged with the trough 18. In the illustrated embodiment, the set of brake lights 19 operably engaged with the trough 18 is used as the third brake light for the trailer 1.

In the illustrated embodiment, the main body 10 may be made of a first material, which includes the circumferential wall 12, the front bulkhead 14, the rear bulkhead 16, and the trough 18. As such, the main body 10 may be made from a metal material, specifically aluminum. Additionally, the circumferential wall 12, the front bulkhead 14, the rear bulkhead 16, and the trough 18 may be made from aluminum material. In other exemplary embodiments, any suitable metal material may be used to make a main body (and its associated components) for a trailer described and illustrated herein.

Referring to FIGS. 1 and 3-6D, the trailer 1 includes an attachment portion 30 operably engaged with the circumferential wall 12 of the main body 10. In the illustrated embodiment, the attachment portion 30 may be a portion of the circumferential wall 12 that extends beyond the rear bulkhead 16 and remote from the interior chamber 17. In other words, the attachment portion 30 and the circumferential wall 12 are a single, unitary member include on the trailer 1. In other exemplary embodiment, an attachment portion may be separate member from a circumferential wall of a main body. As illustrated in FIGS. 4B-5, the attachment portion 30 may include a front end 30A proximate to the rear end 10B of the main body 10 and an opposing rear end 30B. The attachment portion 30 may also include a first side or left side 30C proximate to the left side 10C of the main body 10 and an opposing second side or right side 30D proximate to the right side 10D of the main body 10. The attachment portion 30 may also include a top end 30E proximate to the top end 10E of the main body 10 and an opposing bottom end 30F proximate to the bottom end 10F of the main body 10.

The attachment portion 30 may also include an inner surface 32 that extends from the front end 30A to the rear end 30B. The attachment portion 30 may also include an opposing outer surface 34 that extends from the front end 30A to the rear end 30B. In the illustrated embodiment, the outer surface 34 of the attachment portion 30 is continuous and uninterrupted with the outer surface of the circumferential wall 12. The attachment portion 30 also defines a central passageway 36 that is defined between the front and rear ends 30A, 30B of the attachment portion 30.

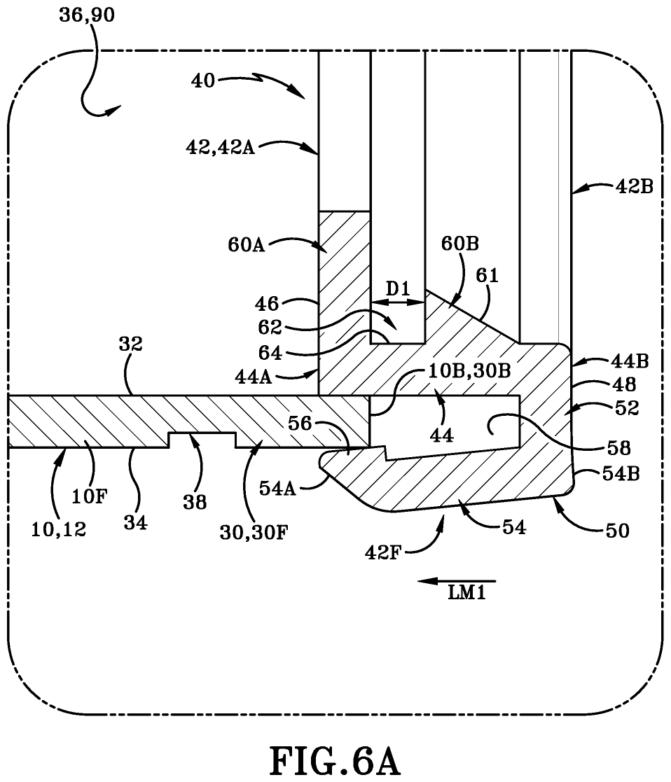

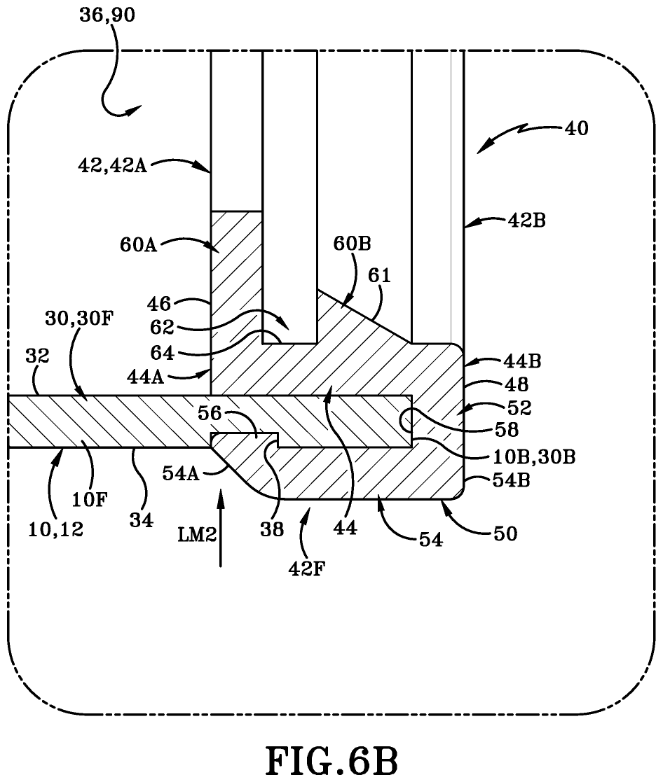

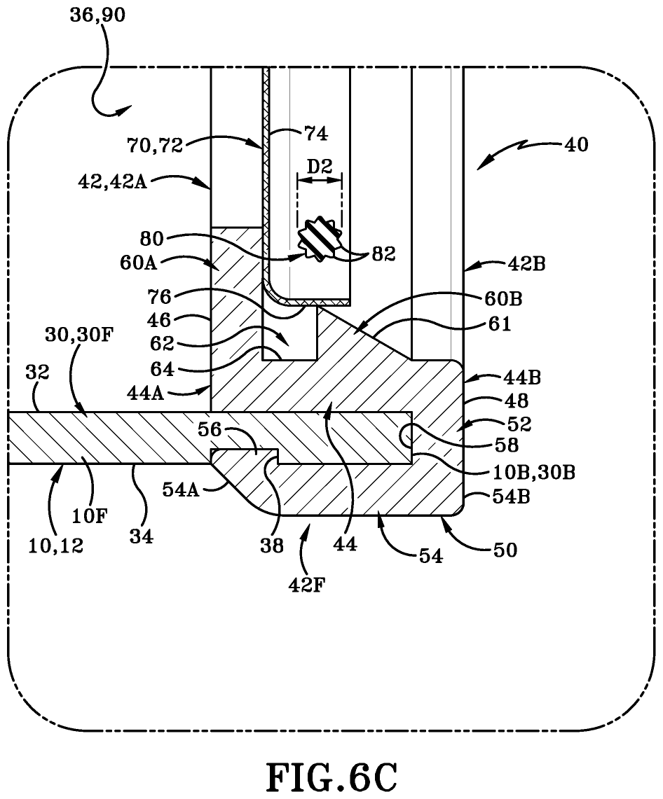

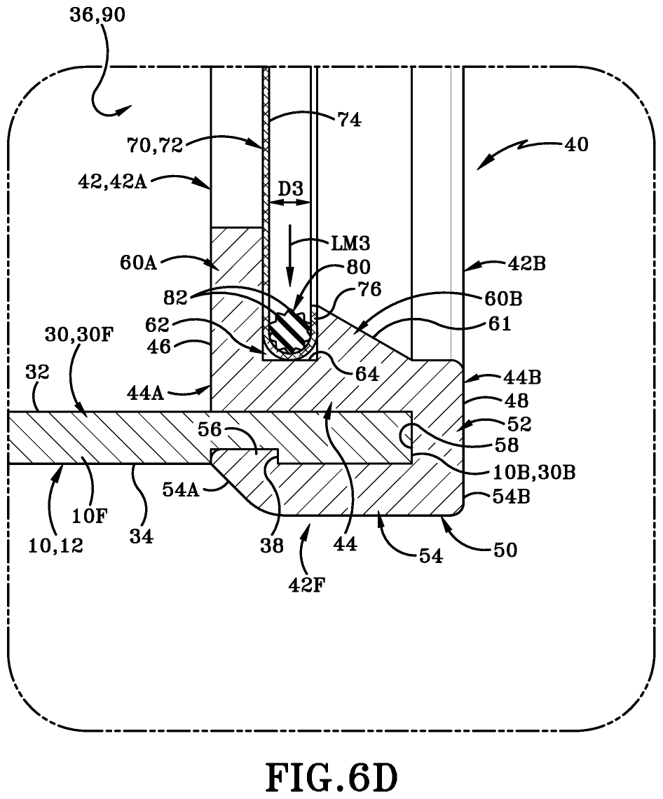

Referring to FIGS. 6A-6D, the attachment portion 30 defines a circumferential groove 38. The circumferential groove 38 defined in the attachment portion 30 extends into the attachment portion 30 from the outer surface 34 towards the inner surface 32. The circumferential groove 38 may also be defined between the front end 30A and the rear end 30B of the attachment portion 30 proximate to the rear end 30B of the attachment portion 30. The circumferential groove 38 may be continuous and uninterrupted along the entire length of the attachment portion 30. In other exemplary embodiments, a plurality of discrete circumferential grooves may be defined in an attachment portion of a trailer. Such use and purpose of the circumferential groove 38 is described in more detail below.

As illustrated in FIGS. 1-6D, a false bulkhead assembly 40 may be operably engaged with the attachment portion 30. The false bulkhead assembly 40 may be adapted to be removable between a disengaged position (see FIGS. 4B and 6A) and an engaged position (see FIGS. 1-4A, 5, 5A, and 6B-6D) with the attachment portion 30. In the illustrated embodiment, the false bulkhead assembly may include a flexible bulkhead (described below) that is made of a different material than the main body 10 and its associated components (i.e., circumferential wall 12, front bulkhead 14, rear bulkhead 16, and trough 18).

Referring to FIGS. 4A-4B, the false bulkhead assembly 40 may include a frame 42. The frame 42 may be adapted to be operably engaged with the attachment portion 30 between the disengaged position and the engaged position described above. As illustrated in FIGS. 4A-4B, the frame 42 may include a front end 42A and an opposing rear end 42B. The frame 42 may also include a first side or left side 42C and an opposing second side or right side 42D. The frame 42 may also include a top end 42E and an opposing bottom end 42F.

Referring to FIGS. 4B-6B, the frame 42 may include a circumferential base wall 44. Referring to FIGS. 6A-6B, the circumferential base wall 44 may have a front end 44A proximate to the front end 42A of the frame 42 and an opposing rear end 44B proximate to the rear end 42B of the frame 42. Still referring to FIGS. 6A-6B, the circumferential base wall 44 may include an inner surface 46 that extends along the front end 44A of the circumferential base wall 44 facing in a direction towards the rear bulkhead 16. The circumferential base wall 44 may also include an opposing outer surface 48 that extends along the rear end 44B of the circumferential base wall 44 facing in an opposing direction away from the rear bulkhead 16.

As illustrated in FIGS. 6A-6B, the circumferential base wall 44 may include a clip 50. The clip 50 may be circumferentially disposed about the entire length of the circumferential base wall 44. The clip 50 may include a support arm 52 that extends radially away from the circumferential base wall 44 proximate to the rear end 44B of the circumferential wall 44. The clip 50 may also include an attachment arm 54 that has a front end 54A remote from the support arm 52 and an opposing second end 54B operably engaged with the support arm 52. In the illustrated embodiment, the circumferential base wall 44, the support arm 52, and the attachment arm 54 may be a unibody, monolithic member that is continuous and uninterrupted. In one exemplary embodiment, a circumferential base wall, a support arm, and an attachment arm may be separate members from one another. In the illustrated embodiment, the support arm 52 and the attachment arm 54 are flexible and/or resilient between a bending position (see FIG. 6A) and a straight position (see FIG. 6B) when operably engaging the frame 42 with the attachment portion 30.

Still referring to FIGS. 6A-6B, the clip 50 may also include a protrusion 56 on the attachment arm 54. The protrusion 56 may be positioned at the front end 54A of the attachment arm 54 and may extend away from the attachment arm 54 towards the base member 44. The protrusion 56 may be configured to operably engage with the attachment portion 30, specifically inside of the circumferential groove 38 of the attachment portion 30. During operation, the protrusion 56 is slideably inserted into the circumferential groove 38 of the attachment portion 30 where the protrusion 56 is positioned orthogonal to the attachment portion 30 when the clip 50 is operably engaged with the attachment portion 30.

The structural configuration between the attachment portion 30 and the clip 50 of the frame 42 is considered advantageous at least because the orthogonal arrangement between the attachment portion 30 and the clip 50 prevents the false bulkhead assembly 40 from disengaging from the attachment portion 30 when being towed by vehicle 2. In other words, orthogonal arrangement between the attachment portion 30 and the clip 50 prevents the false bulkhead assembly 40 from disengaging from the attachment portion 30 when an airstream passes over the false bulkhead assembly 40 when being towed by vehicle 2. As such, the protrusion 56 of the clip 50 provides lateral support to maintain the clip 50 with the attachment portion 30 inside of the circumferential groove 38. Such actions of assembling the false bulkhead assembly 40 with the attachment portion 30 and disassembling of the false bulkhead assembly 40 from the attachment portion 30 are described in more detail.

In the illustrated embodiment, the frame 42 interlockingly engages with the attachment frame 30 via the clip 50 of the frame 42 and the circumferential groove 38 defined by the attachment frame 30. Specifically, the frame 43 interlockingly engages with the attachment frame 30 via a snap-fit mechanism, particularly a cantilever snap-fit mechanism. In other exemplary embodiments, any suitable structural arrangement may be used to operably engage a frame of a false bulkhead assembly with an attachment portion of a trailer. Examples of operably engaging a frame to an attachment portion include attaching, affixing, binding, clamping, coupling, connecting, fastening, fixing, latching, linking, locking, mounting, press-fitting, ratcheting, riveting, securing, welding, and other suitable examples of operably engaging a frame of a false bulkhead assembly with an attachment portion of a trailer.

In the illustrated embodiment, the frame 42 of the false bulkhead assembly 40 operably engages inside of the attachment portion 30 proximate to the outer surface 34 of the attachment portion 30. In one exemplary embodiment, a frame of the false bulkhead assembly may operably engage inside of an attachment portion proximate to an inner surface of the attachment portion. In another exemplary embodiment, a frame of the false bulkhead assembly may operably engage inside of an attachment portion between inner and outer surfaces of the attachment portion. In yet another exemplary embodiment, a frame of the false bulkhead assembly may operably engage with an attachment portion on an inner surface of the attachment portion. In yet another exemplary embodiment, a frame of the false bulkhead assembly may operably engage with an attachment portion on an outer surface of the attachment portion. In yet another exemplary embodiment, a frame of the false bulkhead assembly may operably engage with an attachment portion on both inner and outer surfaces of the attachment portion.

Still referring to FIGS. 6A-6B, a channel 58 may be collectively defined by the circumferential base wall 44, the support arm 52, and the attachment arm 54. The channel 58 may be configured to receive a portion of the attachment portion 30 that extends from the rear end 30B towards the front end 30A. During operation, the rear end 30B of the attachment portion 30 may initially operably engage with the inner surface 46 the circumferential base wall 44 the protrusion 56 of the clip 50. The attachment portion 30 and the frame 42 may be interlocked with one another once the protrusion 56 operably engages with the attachment portion 30 inside of the circumferential groove 38 and the rear end 30B of the attachment portion 30 directly abuts the support arm 52. The channel 58 collectively defined by the circumferential base wall 44, the support arm 52, and the attachment arm 54 allows for a portion of the attachment portion 30 to operably engage with the circumferential base wall 44, the support arm 52, and the attachment arm 54 to provide further structural support and rigidity between the attachment portion 30 and the false bulkhead assembly 40 once assembled together.

Referring to FIGS. 6A-6D, the circumferential base wall 44 may include a front projection 60A extending away from the circumferential base wall 44 and an opposing rear projection 60B extending away from the circumferential base wall 44. The front and rear projections 60A, 60B may be extending along the entire length of the circumferential base wall 44 where the front and rear projections 60A, 60B are continuous and uninterrupted. The rear projection 60B may define a sloped surface 61 that extends from the rear end 44B of the circumferential base wall 44 towards the front end 44A of the circumferential base wall 44. As illustrated in FIGS. 6C-FIG. 6D, a recess 62 is defined between the front and rear projections 60A, 60B by an interior wall 64. In addition, the recess 62 may have a first diameter “D1” that is defined between the front projection 60A and the rear projection 60B. Such use and purpose of the recess 62 is described in more detail below.

As illustrated in FIGS. 2, 4A-5, and 6C-6D, the false bulkhead assembly 40 may include a cover 70 that is operably engaged with the frame 42. The cover 70 may be adapted to be removable from the frame 42 for replacing the cover 70 with a new, different cover for various reasons (stated below). The cover 70 is also adapted to be made from a material that is flexible and resilient. In one exemplary embodiment, a cover may be made a fibrous material that is flexible and resilient. Examples of suitable fibrous material for a cover include synthetic polymeric fibers, metallic fibers, ceramic fibers, and other suitable types of fibrous material of the like may be used based on particular applications of the cover.

The cover 70 may include an interior surface 72, an opposing exterior surface 74, and an outermost edge 76 that is disposed circumferentially about the cover 70 between the front and rear surfaces 72, 74. The cover 70 may also be adapted to provide graphics 78 on the exterior surface 74 of the cover 70 facing rearwardly away from the trailer 1. As illustrated in FIGS. 2-4B, the graphics 78 may display any suitable print, engraving, etching, photograph, design, or any other suitable visual art or typographical marking of the like. Such use of the graphics 78 on the cover 70 is considered advantageous at least because the graphics 78 may provide advertising and marketing methods for a company using said false bulkhead assembly 40 on the trailer 1. As such, the graphics 78 may be custom to a specific entity or product that displays a company's or product name, a company's trademark, or any other suitable use for advertising and marketing a specific company or a specific product being hauled in a tank trailer or tank vehicle like trailer 1.

As illustrated in FIGS. 6C-6D, the false bulkhead assembly 40 may include a retaining member 80. The retaining member 80 may be configured to retain and hold a portion of the cover 70 inside of the recess 62 of the circumferential base wall 44. As illustrated in FIGS. 6C-6D, the retaining member 80 may include a plurality of points or tips 82 to define a star-shaped cross-section. The plurality of tips 82 allows the retaining member 80 to adequately retain the cover 70 inside of the recess 62 by operably engaging with the interior wall 64. In other exemplary embodiments, the retaining member 80 may define any suitable cross-sectional shape or configuration for operably engaging the cover 70 with the circumferential base wall 44. Examples of suitable cross-sectional shapes or configurations for a retaining member include triangular, circular, semi-circular, square, rectangular, pentagonal, hexagonal, octagonal, and other suitable cross-sectional shapes or configurations for a retaining member to maintain a cover with a circumferential base wall. Moreover, the retaining member 80 made be formed of an elastic or resilient material that allows the retaining member 80 to transition its size, shape, or configuration when operably engaged with the circumferential base wall 44 inside of the recess 62. Such transformation of retaining member 80 is described in more detail below.

As illustrated in FIG. 6C, the retaining member 80 may define a second diameter “D2” when disengaged with the circumferential base wall 44. In the illustrated embodiment, the second diameter “D2” of the retaining member 80 that is greater than the first diameter “D1” defining the recess 62. Such difference in diameters between the retaining member 80 and the recess 62 of the circumferential base wall 44 allows the retaining member 80 to suitable retain a portion of the cover 70 circumferentially about the frame 42. During assembly of the false bulkhead assembly 40, the retaining member 80 may transform from a second diameter “D2” to a third diameter “D3” (see FIG. 6D), which is less than the second diameter “D2” yet substantially equal to the first diameter “D1” of the recess 62. Such transformation of the retaining member 80 occurs due to its elastic and/or resilient material transforming when engaged with the interior wall 64 inside of the recess 62. If, however, the retaining member 80 is removed from the circumferential base wall 44, the retaining member 80 may transform from the third diameter “D3” to the second diameter “D2” due to its elastic and/or resilient tendencies.

In the illustrated embodiment, the cover 70 is press-fitted into the circumferential base wall 44 of the frame 42 via the retaining member 80. In other exemplary embodiments, a cover of a false bulkhead assembly may be operably engaged with a circumferential base wall of a frame in any suitable configuration. Examples of operably engaging a cover of a false bulkhead assembly with a circumferential base wall of a frame include attaching, affixing, binding, clamping, coupling, connecting, fastening, fixing, interlocking, latching, linking, locking, mounting, ratcheting, riveting, securing, welding, and other suitable ways of operably engaging a cover of a false bulkhead assembly with a circumferential base wall of a frame.

The structural configuration between the cover 70 and the retaining member 80 is considered advantageous at least because the cover 70 may be interchangeable with another, different cover when removing and reinstalling the retaining member 80 into the frame 42. By having this structural configuration, a user of the false bulkhead assembly 40 may be able to change the cover 70 with another different cover due to various considerations, including removing the current cover 70 due to cover 70 being deteriorated or fade, updating the company name or company logo with a new cover, and other considerations of the like. In one instance, a first cover may be installed with a frame of a false bulkhead assembly having first graphics, and a second cover, different than the first cover, may be installed with the frame of the false bulkhead assembly having second graphics where the first cover is removed from the false bulkhead assembly.

As illustrated in FIG. 5, an exterior chamber 90 may be defined between the rear bulkhead 16 of the main body 10 and the cover 70 once the false bulkhead assembly 40 is fully assembled and the operably engaged with the attachment portion 30 as described above. While not illustrated herein, the exterior chamber 90 may be housed with trailer accessories and/or devices that are concealed by the false bulkhead assembly 40 and exterior to the interior chamber 17. In one instance, electrical wiring, mechanical lines, and other similar devices or components may be housed inside of the exterior chamber 90 such that these devices and components are hidden exterior to the interior chamber 17. Such routing of trailer devices and components exterior to the interior chamber 17 of the main body 10 prevents hazardous material or product loaded inside of the interior chamber 17 to interact with electrical or mechanical components. Such isolation of electrical or mechanical components from the interior chamber 17 may prevent electrical shortages or mechanical issues caused by the hazardous material or product loaded inside of the interior chamber 17. In another instance, the exterior chamber 90 may provide a drainage chamber for exterior drainage systems of the trailer 1 and may conceal any stains or grime on the rear bulkhead 16 created by accumulated precipitation dripping on the rear bulkhead 16.

Having now described the components and assemblies of the trailer 1 with the false bulkhead assembly 40, a method of use and operation of the trailer 1 with the false bulkhead assembly 40 is described below.

Prior to a towing operation, the false bulkhead assembly 40 may be introduced to the attachment portion 30 of the trailer 1. As illustrated in FIG. 6A, the front end 42A of the frame 42 is linearly moved towards the rear end 30B of the attachment portion 30 to operably engage the false bulkhead assembly 40 with the attachment portion 30. The linear movement of the frame 42 is denoted by an arrow labeled “LM1” in FIG. 6A. Upon introduction of the frame 42, the clip 50 begins to transition from a straight position to a bent position upon contacting the attachment portion 30. Specifically, the support arm 52 and the attachment arm 54 begin to transition from the straight position (FIG. 6B) to the bent position (FIG. 6A) upon contacting the attachment portion 30.

The frame 42 may continue to be laterally moved along the attachment portion 30 until the rear end 30B of the attachment portion 30 directly abuts the support arm 52 inside of the channel 58 (see FIG. 66). Additionally, frame 42 may continue to be laterally moved along the attachment portion 30 until the protrusion 56 operably engages with the attachment portion 30 inside of the circumferential groove 38 (see FIG. 66). As illustrated in FIG. 6B, the protrusion 56 of the attachment portion 30 moves upwardly into the circumferential groove 38 of the attachment portion 30 once the protrusion 56 is directly over the circumferential groove 38 and is no longer impeded by the attachment portion 30. The upward linear movement of the attachment arm 54 is denoted by an arrow labeled “LM2” shown in FIG. 6B. This process of laterally moving the frame 42 on the attachment portion 30 is continued until the protrusion 56 is fully seated about the entire circumference of the attachment portion 30. As illustrated in FIG. 6B, the frame 42 of the false bulkhead assembly 40 is operably engaged with the attachment portion 30.

Prior to a towing operation, the cover 70 may be operably engaged with the frame 42 via the retaining member 80. As illustrated in FIG. 6C, a portion of the cover 70 measured from the outermost end 76 of the cover 70 towards the central point of the cover 70 may be introduced to the circumferential base wall 44. Additionally, the retaining member 80 may also be introduced to the circumferential base wall 44. Prior to engagement with the frame 42, the retaining member 80 defines the second diameter “D2” as described above.

Once introduced, the portion of the cover 70 may be downwardly inserted into the recess 62 of the circumferential base wall 44 between the front and rear projections 60A, 60B. During the insertion of the cover 70, the retaining member 80 may also be downwardly inserted into the recess 62 of the circumferential base wall 44 between the front and rear projections 60A, 60B. The downward linear insertion of the retaining member 80 is denoted by an arrow labeled “LM3” in FIG. 6D. During this insertion, the retaining member 80 transforms from the second diameter “D2” to the third diameter “D3” when operably engaging with the interior wall 64 between the first and second projections 60A, 60B. The plurality of tips 82 of the retaining member 80 is also pressed inwardly via the interior wall 64 of the circumferential base wall 44. Such transformation of the retaining member 80 allows for suitable retention between the cover 70 and the frame 42 when the trailer 1 is being towed by the vehicle 2. As illustrated in FIG. 6D, the cover 70 of the false bulkhead assembly 40 is operably engaged with the frame 42 of the false bulkhead assembly 40.

As stated above, the false bulkhead assembly 40 is removable from the attachment portion 30 for various reasons, including obtaining access to exterior chamber 90, obtaining access to the rear bulkhead, and other various reasons of the like. In this situation, the attachment arm 54 is moved downwardly away from the attachment portion 30 until the protrusion 56 is outside of the circumferential groove 38 and disengaged from the attachment portion 30. Once the protrusion 56 is disengaged from the attachment portion 30, the frame 32, including the cover 70 and retaining member 80, may be moved rearwardly away from the attachment portion 30 and away from the trailer 1.

Additionally, the cover 70 may be removed for a new cover for various reasons, including the current cover being damaged, replacing the current cover with another cover having a new typographical print or design, and other various reasons of the like. Such removal of the cover 70 may be performed when the frame 42 of the false bulkhead assembly 40 is still operably engaged with the attachment portion 30 or when the frame 42 of the false bulkhead assembly 40 is operably disengaged from the attachment portion 30. In this situation, the retaining member 80 is moved upwardly away from the recess 62 until the entire retaining member 80 is disengaged from the interior wall 64 and the cover 70. Once disengaged, the cover 70 is also moved upwardly away from the recess 62 until the entire cover 70 is disengaged from the interior wall 64. Upon successful removal of the cover 70 and the retaining member 80 from the frame 42, a new cover with the retaining member 80 may be introduced to and inserted into the recess 62 in the same process stated above. In one exemplary embodiment, a new retaining member substantially similar to retaining member 80 may be inserted with the new cover.

While the false bulkhead assembly 40 is operably engaged with a trailer or towed vehicle 1, a false bulkhead assembly described and illustrated herein may be operably engaged to any suitable vehicle or transportation machine. Examples of suitable vehicles or transportation machines that be configured to operably engaged with a false bulkhead assembly include motorcycles, all-terrain vehicles, cars, sport utility vehicles (SUV), pickup trucks, vans, recreational vehicles, commercial trucks, semi-trailer trucks, tank vehicles, and any other similar vehicles.

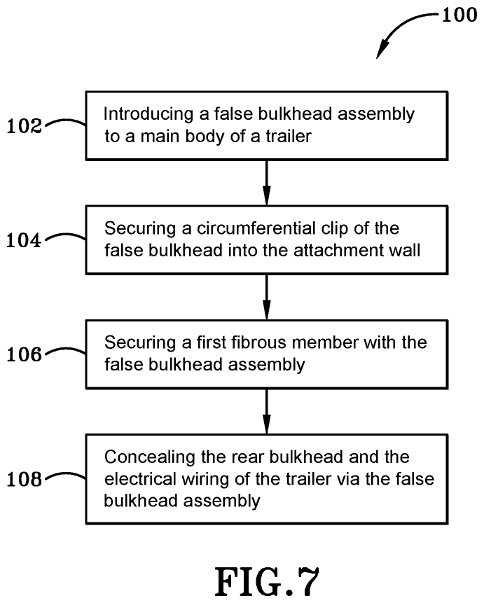

FIG. 7 illustrates a method 100 flowchart for concealing a bulkhead of a vehicle. An initial step 102 of method 100 includes providing a false bulkhead assembly including a frame and a cover. Another step 104 includes engaging the frame with an attachment portion of the vehicle. Another step 106 includes hiding a region of the vehicle with the cover.

In an exemplary embodiment, method 100 may include additional steps for concealing a bulkhead of a vehicle. Optional steps include engaging a clip of the frame with the attachment portion; securing a cover with the frame via a retaining member; and concealing the rear bulkhead of the vehicle via the false bulkhead assembly. Optional steps include inserting a portion of the cover into a recess defined by the clip of the frame; inserting a retaining member into the recess defined by the clip of the frame; and retaining the portion of the cover, via the retaining member, within the recess of the clip. Optional steps include introducing a false bulkhead assembly to a main body of a trailer; securing a clip of the false bulkhead into the attachment portion; securing a first cover with the false bulkhead assembly; and concealing the rear bulkhead and the electrical wiring of the trailer via the false bulkhead assembly. Optional steps may further provide the steps of moving an attachment arm of the clip on the attachment portion; inserting the attachment portion into a channel defined by the clip; bending the attachment arm of the clip from a straight position to a bent position; and inserting a protrusion of the attachment arm into a circumferential groove defined in the attachment portion. An optional step may further provide that the step of inserting a protrusion of the attachment arm into a circumferential groove defined in the attachment portion further includes the protrusion being orthogonal to the longitudinal axis of the attachment portion. Optional steps may further provide the steps of introducing a portion of the first cover into a recess defined by the clip of the false bulkhead assembly; inserting a retaining member into the recess defined by the clip of the false bulkhead assembly; and retaining the portion of the first cover, via the retaining member, within the recess of the clip. An optional step may further provide that the first cover includes a first typographical printing. Optional steps may further provide the steps of removing the retaining member from the recess and the first cover; removing the first cover from the recess; introducing a portion of a second cover into the recess defined by the clip of the false bulkhead assembly, wherein second cover includes a second typographical printing different than the first typographical printing; inserting the retaining member into the recess defined by the clip of the false bulkhead assembly; and retaining the portion of second first cover, via the retaining member, within the recess of the clip. An optional step may further provide a step of effecting to conceal drainage of precipitation in an exterior chamber defined between a rear bulkhead of a main body and the false bulkhead assembly.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A false bulkhead assembly for engagement with a vehicle, said false bulkhead assembly comprising:
a frame adapted to be engaged with the vehicle; and
a cover operably engaged with the frame.

2. The false bulkhead assembly according to claim 1, wherein the frame is removably engaged with the vehicle.

3. The false bulkhead assembly according to claim 1, wherein the cover is selectively positionable outwardly from a wall of the vehicle.

4. The false bulkhead assembly according to claim 1, wherein the cover is selectively positionable parallel to the wall of the vehicle.

5. The false bulkhead assembly according to claim 1, wherein the cover is a fibrous material.

6. The false bulkhead assembly according to claim 1, further comprising:
a retaining member operable to secure the cover to the frame.

7. The false bulkhead assembly according to claim 1, further comprising:
a clip provided on the frame and operable to secure the frame to a wall of the vehicle.

8. The false bulkhead assembly according to claim 1, further comprising:
graphics provided on the cover.

9. In combination,
a trailer comprising a main body having a front bulkhead, a rear bulkhead, and an exterior wall extending between the front bulkhead and the rear bulkhead; and
a false bulkhead assembly positioned adjacent one of the front bulkhead and the rear bulkhead of the trailer.

10. The combination according to claim 9, wherein the trailer further comprises:
an attachment portion; wherein the false bulkhead assembly is removably engageable with the attachment portion.

11. The combination according to claim 10, wherein the false bulkhead assembly further comprises:
a frame operably engageable with the attachment portion; and
a cover operably engaged with the frame.

12. The combination according to claim 11, wherein the false bulkhead assembly further includes:
graphics provided on the cover.

13. The combination according to claim 11, wherein the frame further comprises:
a base wall; and
a clip extending from the base wall, wherein the clip is configured to operably engage the frame with the attachment portion of the trailer.

14. The trailer of claim 13, wherein the clip further comprises:
a support arm extending away from the base wall; and
an attachment arm extending outwardly away from a first end of the support arm, wherein the attachment arm and support arm are moveable between a straight position and a bent position when operably engaging the attachment arm with the attachment portion.

15. The trailer of claim 14, wherein the clip further comprises:
a protrusion extending away from an opposing second end of the attachment arm, wherein the protrusion is configured to operably engage with the attachment portion.

16. The trailer of claim 15, wherein the attachment portion further comprises:
a groove extending into the attachment portion, wherein the groove is configured to receive and house the protrusion.

17. The trailer of claim 13, wherein the false bulkhead assembly further comprises:
a retaining member configured to retain the cover with the frame.

18. A method of concealing a bulkhead of a vehicle, comprising steps of:
providing a false bulkhead assembly including a frame and a cover;
engaging the frame with an attachment portion of the vehicle; and
hiding a region of the vehicle with the cover.

19. The method of claim 18, further comprising:
engaging a clip of the frame with the attachment portion of the vehicle; and
securing a cover with the frame via a retaining member.

20. The method of claim 19, further comprising:
inserting a portion of the cover into a recess defined by the clip of the frame;
inserting the retaining member into the recess defined by the clip of the frame; and
retaining the portion of the cover, via the retaining member, within the recess of the clip.
